(19) United States
(12) Patent Application Publication
(10) Pub. No.: US 2013/0249821 A1
(43) Pub. Date: Sep. 26, 2013

(54) Method and System for Virtual Keyboard

(71) Applicant: The Board of Trustees of the Leland Stanford, Junior, University, (US)

(72) Inventors: Sohan Dharmaraja, Colombo (LK); Adam Duran, Ann Arbor, MI (US); Adrian Lew, Stanford, CA (US)

(73) Assignee: The Board of Trustees of the Leland Stanford, Junior, University, Palo Alto, CA (US)

(21) Appl. No.: 13/628,843

(22) Filed: Sep. 27, 2012

Related U.S. Application Data
(60) Provisional application No. 61/539,957, filed on Sep. 27, 2011.

(51) Int. Cl. G06F 3/02

(52) U.S. Cl. CPC G06F 3/0219
USPC 345/173

(57) ABSTRACT

In an embodiment of the invention, a virtual Braille keyboard is disclosed that makes use of a touch-sensitive computing device. In an embodiment of the invention, a calibration procedure is initiated by a user for determining the general position of various finger tips that will subsequently be used for the input of Braille characters. After calibration, the operation of a physical Braille keyboard is mimicked using methods according to an embodiment of the invention.

GOVERNMENT RIGHTS

This invention was made with Government support under contract W911NF-07-2-0027 awarded by the U.S. Army Research Laboratory. The Government has certain rights in this invention.

### CROSS-REFERENCE TO RELATED APPLICATIONS

This application claims priority to U.S. Provisional Application No. 61/539957 filed Sep. 27, 2011, which is hereby incorporated by reference in its entirety for all purposes.

### FIELD OF THE INVENTION

This invention relates, generally, to devices for providing input to a computer. More particularly, it relates to keyboard input devices including Braille input devices for entering information to a computing device such as a tablet computer that may have no tactile reference points.

### BACKGROUND OF THE INVENTION

Blind and low-vision persons frequently use Braille as a means of writing and reading text. Braille characters are generated by selective activation of a grid of dots. Various devices are available for entering Braille text into a computer memory and for displaying the stored text.

A typical Braille keyboard includes two sets of four dot keys per set and a space key. In some keyboards, a cursor router key is provided for navigating through stored text. A Braille keyboard may be a stand-alone peripheral device for connecting to a computer, or it may be formed as an integral part of a computer. A so-called “notetaker” is a portable computer used by blind and low vision students.

Prior art Braille keyboards have generally been rigid, external devices with keys of fixed spacing. Such keyboards have lacked flexibility and have been very expensive. For example, a Braille keyboard at the time of the present invention generally cost several thousand dollars. Also, despite the fact that computing devices have become very small (e.g., smart phones and tablets), Braille keyboards have remained large and cumbersome and generally not compatible with such modern devices. For example, whereas modern computer systems are designed to be sleek and lightweight, traditional Braille keyboards are large and cumbersome.

Accordingly, there is a need for a Braille input device with increased flexibility that is compatible with modern electronic devices. Moreover, there is a need for an input device that can be used on a desktop as well as in a mobile manner away from a desktop.

### SUMMARY

In an embodiment of the invention, an improved Braille keyboard is disclosed that makes use of a touch sensitive screen for implementing a virtual Braille keyboard. In an embodiment of the invention, a calibration procedure is initiated by a user for determining the general position of various finger tips that is subsequently used for the input of Braille characters. After calibration, the operation of a physical Braille keyboard is mimicked using methods according to an embodiment of the invention.

The virtual Braille keyboard of an embodiment of the present invention allows Braille to be typed on devices with touch-surfaces and touch-screens including, for example, iPads, iPhones, generic touchpads, Android tablets, and Android phones. The virtual Braille keyboard of the present invention is an integral solution to the manner in which visually impaired people interact with these devices.

In an embodiment of the invention, the virtual Braille keyboard is used on a desktop in front of a user. In another embodiment of the invention, the virtual Braille keyboard is used in a vertical orientation by suspending a touch sensitive screen, for example, from a user's neck, such as through the use of a lanyard.

Embodiments of the present invention can be used by limited-sight users as well as sighted users. Also, whereas embodiments of the present invention implement a Braille keyboard layout, still other embodiments can implement other keyboard layouts including QWERTY and Dvorak keyboard layouts.

An advantage of embodiments of the present invention is that the hand, wrist, and arms of a user can be positioned in a more natural and closer to neutral position. Such positioning has been found to reduce or eliminate fatigue and repetitive motion stress disorders that have become an increasing problem in today's computationally intensive world.

These and other embodiments are described in further detail below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a computer system on which embodiments of the present invention can be practiced.

FIG. 2 is a diagram of an arrangement of dots used to represent Braille characters.

FIG. 3 is a diagram of the arrangement of dots used to represent the alphabet using Braille characters.

FIG. 4 is a diagram of the arrangement of dots used to represent numbers using Braille characters.

FIG. 5 is a drawing of a keyboard used to enter Braille characters.

FIGS. 6A and 6B are diagrams that demonstrate the manner in which an embodiment of the present invention can be calibrated for different users.

FIG. 7 is a diagram that demonstrates the manner in which an embodiment of the present invention is implemented in a vertical orientation.

FIG. 8 is a flowchart for a method according to an embodiment of the present invention.

### DETAILED DESCRIPTION

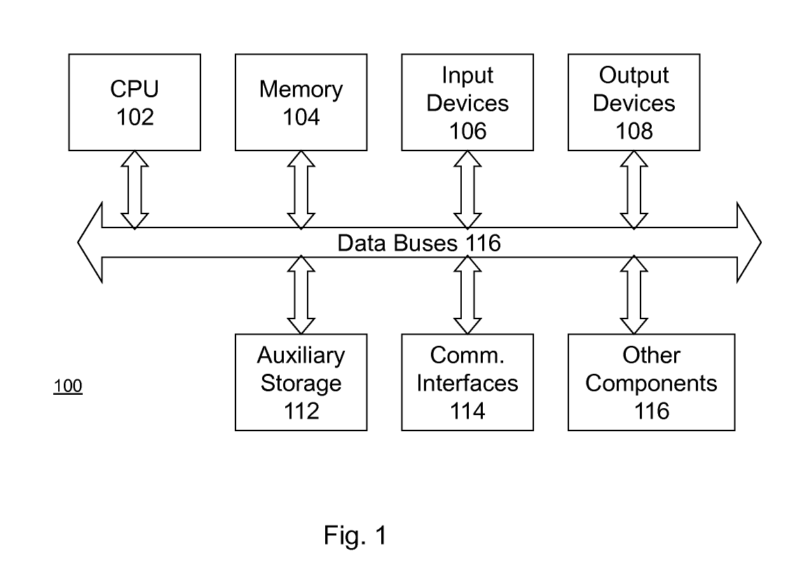

Among other things, the present invention relates to methods, techniques, and algorithms that are intended to be implemented in a digital computer system 100 such as generally shown in FIG. 1. Such a digital computer or embedded device is well-known in the art and may include the following.

Computer system 100 may include at least one central processing unit 102 but may include many processors or processing cores. Computer system 100 may further include memory 104 in different forms such as RAM, ROM, hard disk, optical drives, and removable drives that may further include drive controllers and other hardware. Auxiliary storage 112 may also be include that can be similar to memory 104 but may be more remotely incorporated such as in a distributed computer system with distributed memory capabilities.

Computer system 100 may further include at least one output device 108 such as a display unit, video hardware, or other peripherals (e.g., printer). At least one input device 106 may also be included in computer system 100 that may include a pointing device (e.g., mouse), a text input device (e.g., keyboard), or touch screen. The at least one input device 106 may also include a touchpad as known to those of ordinary skill in the art and as described in certain embodiments herein.

Communications interfaces 114 also form an important aspect of computer system 100 especially where computer system 100 is deployed as a distributed computer system. Computer interfaces 114 may include LAN network adapters, WAN network adapters, wireless interfaces, Bluetooth interfaces, modems and other networking interfaces as currently available and as may be developed in the future.

Computer system 100 may further include other components 116 that may be generally available components as well as specially developed components for implementation of the present invention. Importantly, computer system 100 incorporates various data buses 116 that are intended to allow for communication of the various components of computer system 100. Data buses 116 include, for example, input/output buses and bus controllers.

Computer system 100 may be implemented, for example, as a touch pad computer system as described further below. For example, an embodiment of the present invention is implemented on a tablet computer running an Android operating system, and another embodiment is implemented on a tablet computer running Apple's iOS operating system. In another embodiment, the present invention is implemented on a touch sensitive smart phone or similar device. Importantly, the present invention is not limited to computer system 100 as known at the time of the invention. Instead, the present invention is intended to be deployed in future computer systems with more advanced technology that can make use of all aspects of the present invention. It is expected that computer technology will continue to advance, but one of ordinary skill in the art will be able to take the present disclosure and implement the described teachings on the more advanced computers or other digital devices such as mobile telephones or smart devices as they become available. Moreover, the present invention may be implemented on one or more distributed computers. Still further, the present invention may be implemented in various types of software languages including Java, Javascript, C, C++, Objective-C, and others. Also, one of ordinary skill in the art is familiar with compiling software source code into executable software that may be stored in various forms and in various media (e.g., magnetic, optical, solid state, etc.). One of ordinary skill in the art is familiar with the use of computers and software languages and, with an understanding of the present disclosure, will be able to implement the present teachings for use on a wide variety of computers.

The present disclosure provides a detailed explanation of the present invention with detailed explanations that allow one of ordinary skill in the art to implement the present invention into a computerized method. Certain of these and other details are not included in the present disclosure so as not to detract from the teachings presented herein but it is understood that one of ordinary skill in the art would be familiar with such details.

To be described below is a Braille input device as implemented on an Android tablet with a touch sensitive screen. The described embodiment has been implemented in Java but can be implemented in many other forms. One of ordinary skill in the art will understand, however, that the teachings of the present invention are not limited to such device and may be implemented on devices that are currently available and as may become available in the future.

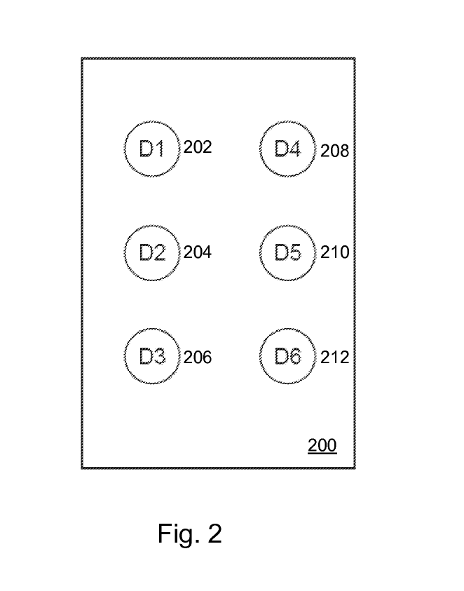

Before proceeding to describe certain aspects of the present invention, it is useful to have an understanding of the Braille alphabet. Shown in FIG. 2 is grid 200 of a Braille alphabet that includes six dots: dot D1 201, dot D2 202, dot D3 203, dot D4 204, dot D5 205, and dot D6 206. Dots D1-D6 (201-206, respectively) are positioned like the figure six on a die with two parallel vertical lines of three dots each. From the six dots that make up grid 200, 64 different signs can be created. In Braille, the reading direction is the same as for regular type and the rules for hyphenation that apply for regular fonts also apply in Braille.

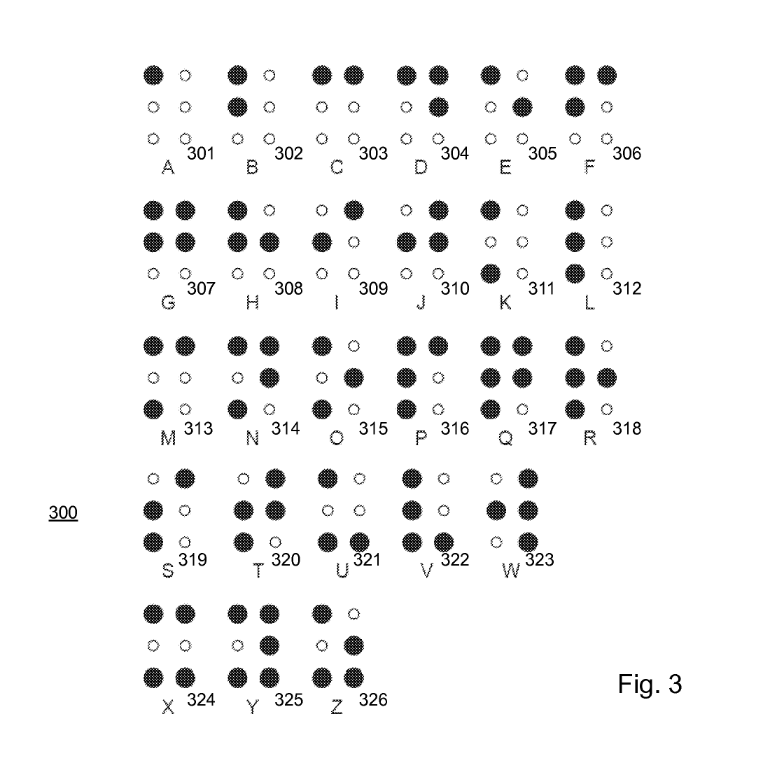

Braille character sets consist of letters, numbers, punctuation, symbols and special characters. Shown in FIG. 3 is the Braille alphabet for the letters A through Z (i.e., grids 301-326, respectively). For example, grid 301 indicates that the letter A is represented by raised dot D1 (shown as a darkened dot; see FIG. 2). Grid 302 indicates that the letter B is represented by raised dots D1 and D2 (see FIG. 2). The rest of the alphabet is as shown in FIG. 3.

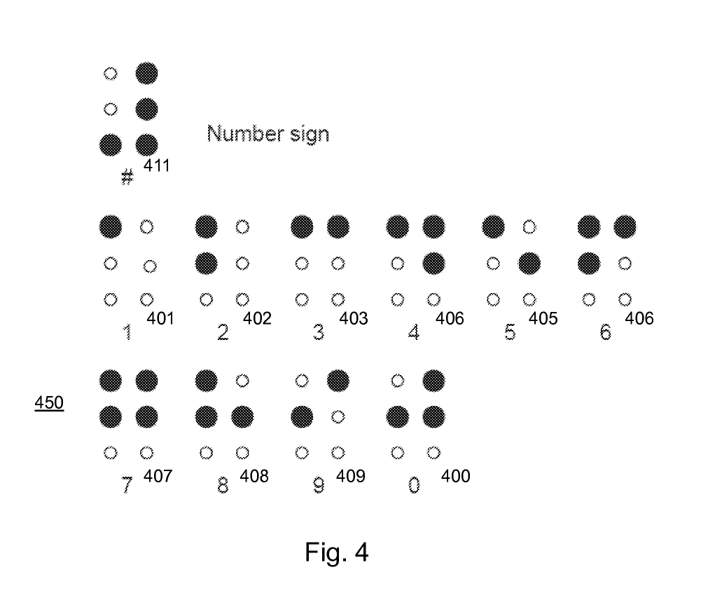

Shown in FIG. 4 is the Braille representation for numbers 0 through 9 (i.e., grids 400-409, respectively) as well as the number sign 411. For example, in order to represent the number 1, the number sign (i.e., grid 411) is used to signal that a number is to be represented followed by grid 401 for the number 1. Note that without the number sign 411 indicator, grid 401 is identical to grid 301. The rest of the number representation is as shown in FIG. 4.

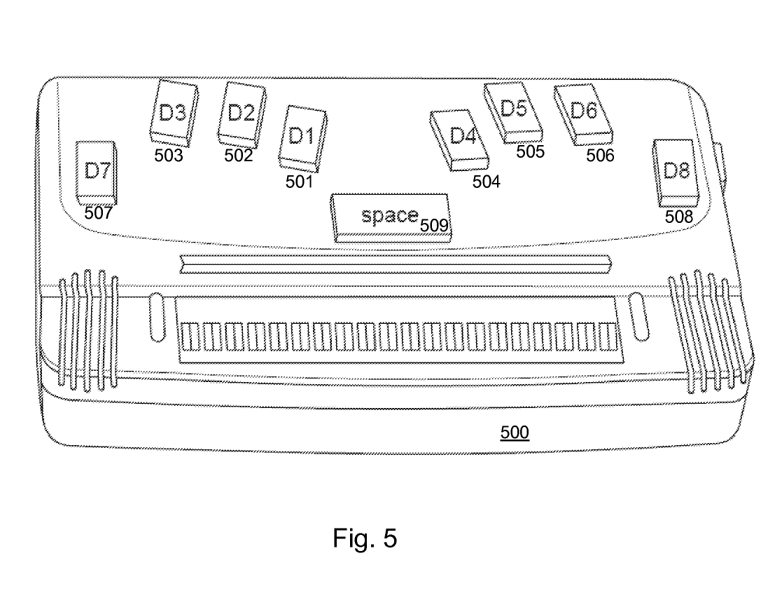

Various devices are available for entering Braille text. A typical Braille keyboard that includes two sets of four dot keys per set and a space key. In some keyboards, a cursor router key is provided for navigating through stored text. For example, shown in FIG. 5 is Braille keyboard 500 that includes dot keys 501-506 that represent the dots of grid 200 of FIG. 2. Using dot keys 501-506 of FIG. 5, the various alphanumeric characters of FIGS. 3 and 4 can be represented. Also shown in FIG. 5 are dot keys D7 507 and D8 508 that can be used for specialized functions. For example, D7 507 can be implemented as a backspace key and D8 508 can be implemented as a carriage return or enter key. Moreover, space key 509 is shown that can be used to provide spacing between characters. Still other keys can be included on a Braille keyboard to provide further functionality.

Prior art Braille keyboards have generally been rigid, external devices with keys of fixed spacing. Such keyboards have lacked flexibility and have been expensive. For example, a Braille keyboard at the time of the present invention can cost several thousand dollars. Also, despite the fact that computing devices have become very small (e.g., smart phones and tablets), Braille keyboards have remained large and cumbersome and generally not compatible with modern electronic devices.

In an embodiment of the present invention, a Virtual Braille Keyboard is provided on a touch sensitive computer such as a tablet computer with a touch screen. In an embodiment of the invention, button location and sizes are determined from a calibration routine where the user touches his typing digits to the screen once. Then, a method of the present invention generates a virtual Braille keyboard based on these touch locations. This allows users with different typing orientations to use the keyboard efficiently because button attributes (e.g., size and location) are set by the user in his preferred orientation.

The present invention provides advantages over prior art devices that present a physical keyboard with fixed dimensions that cannot be adjusted to a user's hand. The present invention provides a customized keyboard that can be quickly recalibrated should the user desire a different orientation. Indeed, the present invention provides ergonomic advantages because the user need to keep his hands in a fixed position for extended periods of time.

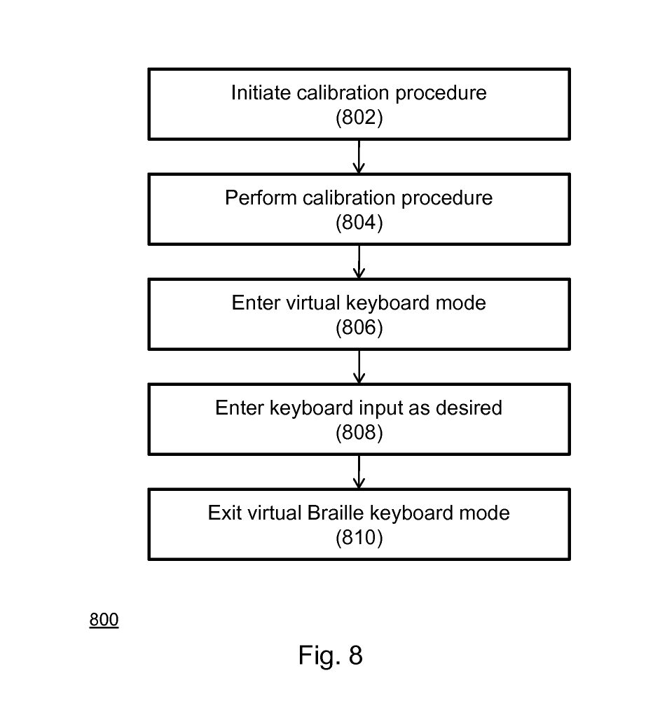

Shown in FIG. 8 is a flow diagram of method steps for implementing a virtual Braille keyboard according to an embodiment of the present invention. It should be noted that the described embodiments are illustrative and do not limit the present invention. It should further be noted that the method steps need not be implemented in the order described. Indeed, certain of the described steps do not depend from each other and can be interchanged. For example, as persons skilled in the art will understand, any system configured to implement the method steps, in any order, falls within the scope of the present invention.

At step 802, a calibration procedure is initiated. The calibration procedure of step 802 advantageously provides for customization of a virtual keyboard to a user's fingers and preferred orientation, for example. In an embodiment of the invention, the calibration procedure is initiated by performing a predetermined action on the touch sensitive screen. Such predetermined action is preferably an action that is not commonly observed during the operation of the virtual keyboard of the present invention. Also, such predetermined action is preferably not observed during other normal operation of the computer system on which the present invention is implemented (e.g., tablet).

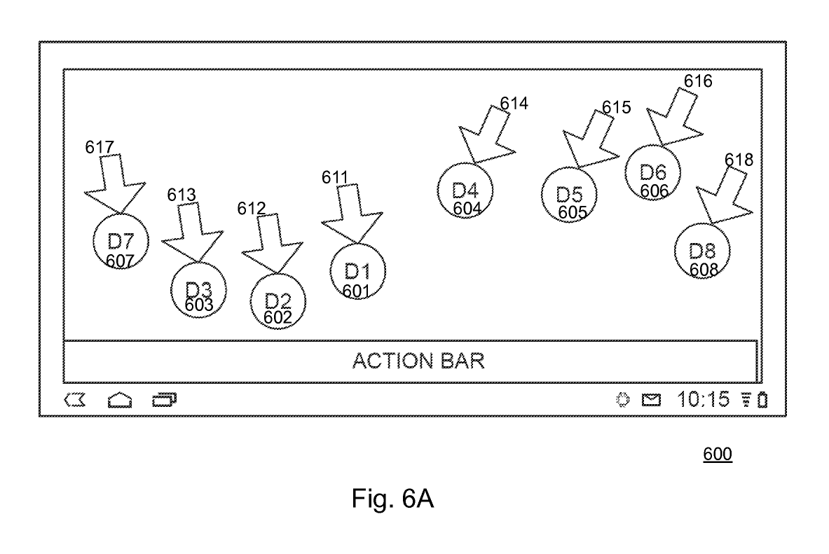

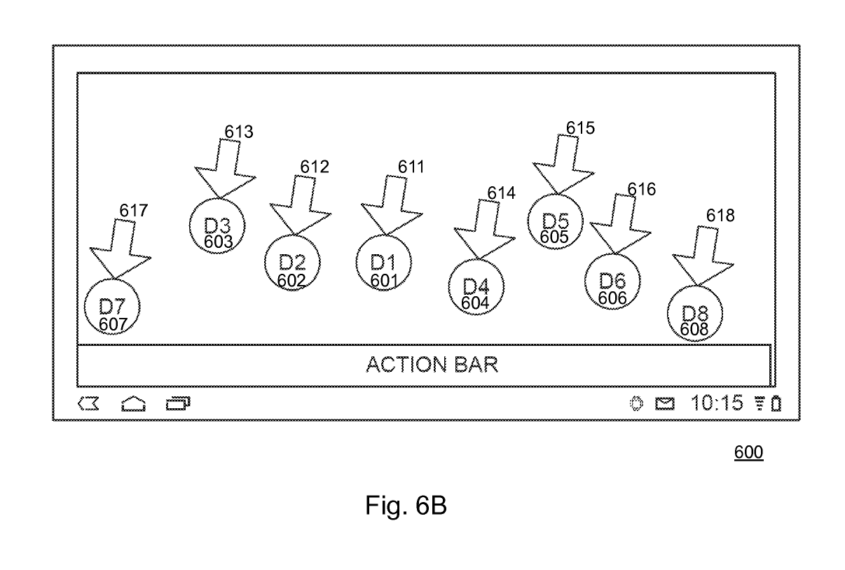

Shown in FIG. 6A is an example of a predetermined action for initiating a calibration procedure. In this embodiment, the calibration procedure is initiated by tapping the eight fingers (not the thumbs) on the touch sensitive screen. As shown, arrows 611-617 represent the simultaneous vertical tapping motion of the user's left hand and arrows 614-618 represent the simultaneous vertical tapping motion of the user's right hand. In another embodiment of the present invention, the calibration procedure is initiated by dragging a predetermined number of fingertips (e.g., eight) across the touch sensitive screen. The calibration procedure can be initiated using many other techniques as would be understood by one of ordinary skill in the art upon understanding the present disclosure.

Upon entering the calibration mode, an embodiment of the present invention performs the calibration procedure of step 804. In an embodiment of the present invention, the calibration procedure of step 804 obtains the general size and vicinity of four (or five) fingers of each hand.

For example, in performing the calibration procedure of step 804, the positions of a user's hand can be determined by touching a user's fingertips to the touch screen. Shown in FIG. 6A are dots D1-D8 (601-608, respectively) that represent the manner in which a user's hand is physically configured to touch screen 600. In another calibration procedure according to step 804, the same user may desire to change his hand or fingertip configuration to that as shown in FIG. 6B. Shown in FIG. 6B are dots D1-D8 (601-608, respectively) that represent a different manner in which a user's hand is physically configured to touch screen 600. Alternatively, the configuration as shown in FIG. 6B can represent a preferred configuration for a different user.

Note that the differences in the position of the fingers as shown in FIGS. 6A and 6B can be attributed to various factors including the size of the hand and the length of the fingers. The sizes of the finger tips can also vary. Whereas in a prior art system, a user would have to adjust to the Braille input device, embodiments of the present invention are able to adjust to the user.

In this way, a method according to an embodiment of the present invention is able to attribute tactile input to the various fingers of a user's hand. In an embodiment of the invention, the user's various fingers are allowed to vary within a predetermined range. For example, a corresponding dot (e.g., D1) is considered to have been tapped or touched if a fingertip is detected within the predetermined range. In yet another embodiment of the invention, the user's various fingers are allowed to drift across the touch sensitive screen while tracking the positions of the various fingers of the user's hand. For example, the user's hand is allowed to drift across the screen while generally keeping the fingertips in a predetermined orientation. In such an embodiment, the relative sizes and positions from the calibration procedure are maintained while their collective position is translated across the touch sensitive screen. In this way, subtle or gradual movements are allowed while not requiring a further initiation or calibration procedure.

Advantageously, such calibration procedure allows for a custom fit to a user's hands and fingertips. Whereas prior art systems used a rigid input device for all users, not all users would find such rigid keyboard desirably configured. For example, a child would need a smaller keyboard than an adult, but none may be available that properly fit either the child or the adult. The present invention allows for customization and, therefore, allows for more comfortable operation by a user.

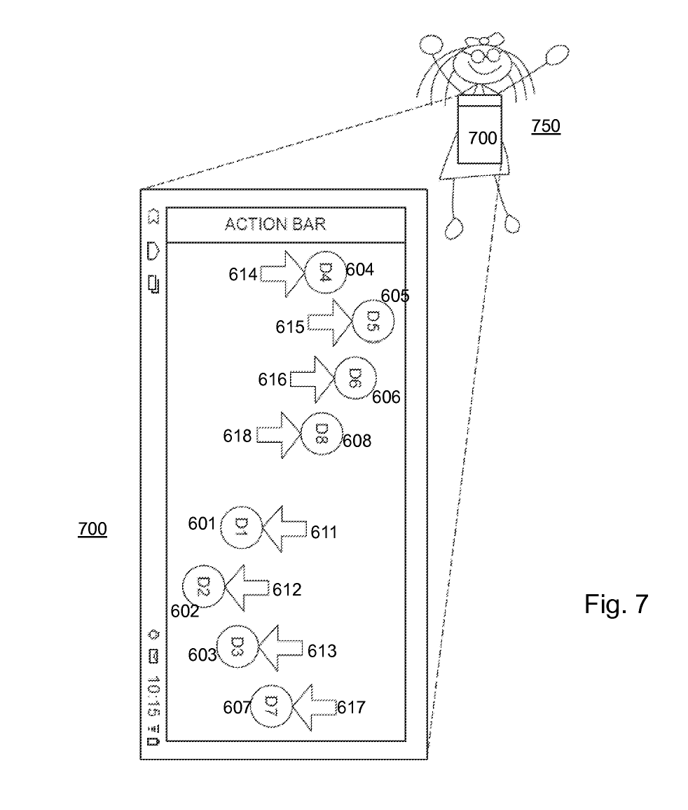

FIGS. 6A and 6B showed the manner in which the virtual keyboard according to an embodiment of the invention is used when a touch sensitive device is used on a desktop in front of the user. Advantageously, however, the present invention can be used in other orientations. For example, shown in FIG. 7 is the result of a calibration procedure according to another embodiment of the invention. As shown in FIG. 7, user 750 vertically suspends a touch sensitive device (e.g., tablet computer) from his neck using a lanyard. When used in this manner, the fingertips of the user's right hand may touch the device as represented by dots D1-D3 and D7 (601-603 and 607, respectively) and the user's right hand may touch the device as represented by dots D4-D6 and D8 (604-606 and 608, respectively) in FIG. 7.

In this embodiment of the present invention, the virtual Braille keyboard can be used while a user is standing. Indeed, the virtual Braille keyboard of the present invention can be used while a user is walking. In this way, a user is not bound to a rigid hardware device that can only be used on a desktop. A further advantage of the embodiment of FIG. 7 is that the hand, wrist, and arms of a user can be positioned in a more natural and closer to neutral position. Such positioning has been found to reduce or eliminate fatigue and repetitive motion stress disorders that have become an increasing problem in today's computationally intensive world. Indeed, other embodiments of the present invention include ergonomic keyboards for sighted as well as limited sight users.

After completing the calibration procedure, a method of the present invention enters a virtual keyboard mode at step 806 where the input received from the user's various fingers is interpreted as keyboard input at step 808. In an embodiment, the operation of the various keys of prior art physical keyboards is mimicked on the touch sensitive screen. It should be noted that embodiments of the present invention can be used by limited-sight users as well as sighted users. Also, whereas embodiments of the present invention implement a Braille keyboard layout, still other embodiments can implement other keyboard layouts including QWERTY and Dvorak keyboard layouts.

From time to time during operation of a computer such as a tablet, it may be necessary to exit the virtual Braille keyboard mode of the present invention. In an embodiment, a user exits the virtual keyboard mode at step 810 by performing a predetermined action on the touch sensitive screen. In an embodiment of the invention, such predetermined action is the same as for entering the calibration process at step 802. In this way, the virtual keyboard mode is essentially toggled by the predetermined action. In another embodiment of the invention, the predetermined action for exiting the virtual keyboard mode is different from the calibration action. For example, the virtual Braille keyboard mode can be exited by dragging an odd number of fingers across the touch sensitive screen. Many other alternatives are possible as would be understood by those of ordinary skill upon understanding the present disclosure.

In a scenario for the present invention, a user is able to quickly enter (step 802) and exit (step 810) the virtual keyboard mode of the present invention as necessary. Advantageously, no external device is required.

Using embodiments of the present invention, limited-sight users can take notes, compose emails and text messages, in a variety of formats (e.g., English, Greek, Mathematics, etc). In an embodiment of the invention, the virtual keyboard is integrated into the device's operating system. Standard typesetting is also possible with the present invention by, for example, using Braille Grade 2 (for word contractions) and other basic functionality like saving, and loading of previously typed text. Additional language and typesetting support can be added through software modifications as is known to those of ordinary skill in the art. Still other embodiments of the present invention can be used by sighted users. For example, sighted users can make use of a Braille keyboard scheme. Alternatively, sighted users can make use of other keyboard schemes including QWERTY and Dvorak.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as flash memory, ROM chips or any type of solid-state non-volatile semiconductor memory) on which information is permanently stored; and (ii) writable storage media (e.g., Flash media or hard-disk drive or any type of solid-state random-access semiconductor memory) on which alterable information is stored.

It should be appreciated by those skilled in the art that the specific embodiments disclosed above may be readily utilized as a basis for modifying or designing other techniques for carrying out the same purposes of the present invention. It should also be appreciated by those skilled in the art that such modifications do not depart from the scope of the invention as set forth in the appended claims.

We claim:

1. A computer-implemented method for implementing a virtual keyboard, comprising:
receiving a predetermined input that indicates the initiating of a calibration procedure;
receiving input from a touch-sensitive device that identifies a predetermined gesture of a predetermined number of fingertips of a user on the touch-sensitive device; and
calibrating a position of a user's predetermined number of fingertips for use with the virtual keyboard.
receiving tactile information from the predetermined number of fingertips.

2. The computer-implemented method of claim 1, further comprising calibrating the size of each of the predetermined number of fingertips.

3. The computer-implemented method of claim 1, further comprising determining an allowed range of movement on the touch-sensitive device for movement of each of the predetermined number of fingertips

4. The computer-implemented method of claim 1, wherein the predetermined number of fingertips is eight.

5. The computer-implemented method of claim 1, wherein the predetermined number of fingertips is ten.

6. The computer-implemented method of claim 1, wherein the received tactile information is in accordance with a Braille keyboard.

7. The computer-implemented method of claim 1, wherein the received tactile information is in accordance with a QWERTY keyboard.

8. The computer-implemented method of claim 1, wherein the received tactile information is in accordance with a Dvorak keyboard.

9. The computer-implemented method of claim 1, wherein the predetermined input is input responsive to tapping a predetermined number of fingertips on a touch-sensitive device.

10. The computer-implemented method of claim 1, wherein the predetermined gesture is tapping a predetermined number of fingertips on a touch-sensitive device.

11. A computer-readable medium including instructions that, when executed by a processing unit, cause the processing unit to execute a method for implementing a virtual keyboard, by performing the steps of:
receiving a predetermined input that indicates the initiating of a calibration procedure;
receiving input from a touch-sensitive device that identifies a predetermined gesture of a predetermined number of fingertips of a user on the touch-sensitive device; and
calibrating a position of a user's predetermined number of fingertips for use with the virtual keyboard.
receiving tactile information from the predetermined number of fingertips.

12. The computer-readable medium of claim 11, further comprising calibrating the size of each of the user's predetermined number of fingertips.

13. The computer-readable medium of claim 11, further comprising determining an allowed range of movement on the touch-sensitive device for movement of each of the predetermined number of fingertips

14. The computer-readable medium of claim 11, wherein the predetermined number of fingertips is eight.

15. The computer-readable medium of claim 11, wherein the predetermined number of fingertips is ten.

16. The computer-readable medium of claim 11, wherein the received tactile information is in accordance with a Braille keyboard.

17. The computer-readable medium of claim 11, wherein the received tactile information is in accordance with a QWERTY keyboard.

18. The computer-readable medium of claim 11, wherein the received tactile information is in accordance with a Dvorak keyboard.

19. The computer-readable medium of claim 11, wherein the predetermined input is input responsive to tapping a predetermined number of fingertips on a touch-sensitive device.

20. The computer-readable medium of claim 11, wherein the predetermined gesture is tapping a predetermined number of fingertips on a touch-sensitive device.

21. A computing device comprising:
a data bus;
a memory unit coupled to the data bus;
a processing unit coupled to the data bus and configured to
receive a predetermined input that indicates the initiating of a calibration procedure;
receive input from a touch-sensitive device that identifies a predetermined gesture of a predetermined number of fingertips of a user on the touch-sensitive device; and
calibrate a position of a user's predetermined number of fingertips for use with the virtual keyboard.
receive tactile information from the predetermined number of fingertips.
